(19) United States
(12) Patent Application Publication
(10) Pub. No.: US 2008/0077995 A1
(43) Pub. Date: Mar. 27, 2008

(54) Network-Based Security Platform

(76) Inventor: Jon Curnyn, Buckinghamshire (GB)

Correspondence Address: Tarolli Sundheim Covell & Tummino LLP, 1300 East Ninth Street, Suite 1700, Cleveland, OH, 44114, US

(21) Appl. No.: 11/662,673

(22) PCT Filed: Sep. 15, 2005
(86) PCT No.: PCT/GB05/03577

§ 371 Date: Mar. 13, 2007

(30) Foreign Application Priority Data
Sep. 15, 2004 (GB) 0420548.0

(51) Int. Cl. H04L 29/06; G06F 1/00

(52) U.S. Cl. 726/27

(57) ABSTRACT

A content processing architecture-and-method enabling high throughput, low-latency services to be performed on streamed data. A stream controller (300) receives and stores the streamed data, and also coordinates the performance of functions upon the streamed data by a plurality of stream processors (310). The results of the functions are used by one or more service processors (320) to effect decisions as to whether a subscriber should be allowed access to the streamed content. The service processors instruct the stream controller to act in accordance with the decisions.

### FIELD OF THE INVENTION

The present invention relates to a network-based content processing platform. In particular, the invention relates to a security platform that allows network service providers to deliver managed content security services to their subscribers.

### BACKGROUND TO THE INVENTION

The internet presents many opportunities for malicious and accidental proliferation of data that may compromise the security of networked servers and workstations. One part of the security of a system relates to the data transmitted through it. Examples of this data, or content, include e-mails, web pages, instant messages, streams of information, and streams of packets.

Content security is distinct from other areas of computer related security, such as encryption/authentication solutions (e.g. Virtual Private Networks or VPNs), or network protection (e.g. firewalls). As the name suggests, content security applications operate on content providing protection against dangerous, destructive, unsolicited or offensive content.

A variety of content security products currently exist, and each typically protects against a limited number of attacks. For example, anti-virus (AV), anti-spam (AS), and web access filtering are well known and have been implemented at various points in network architecture. However, a number of disadvantages in the current handling of content security issues are readily apparent.

In particular, the resources needed to combat the broad and ever-expanding range of attacks are not readily available at any level in typical networks. An internet service provider (ISP), or other network administrator, offering content security services may find adding new security systems prohibitively expensive due to the large number of subscribers, while the end user is unlikely to have the expertise to combat emerging threats.

More significant defects in current content security are a result of the very premises on which they are built, relying as they do on conventional computing architecture and practice.

To summarise, content security is typically approached in three ways: through primarily software based solutions, executing on standard platforms such as personal computers (PCs); through hardware acceleration products for these software based solutions, e.g. taking the form of peripheral component interconnect (PCI) cards, which provide high speed operation of a few functions; or using a few network based products, offering hardware accelerated functionality for specific problems.

Consider first the fundamental defects with user or end-point security products. Individual point products installed on a PC can only analyse traffic sent to that PC, which does not allow analysis of information pertinent to detecting network borne content threats. For example, spam and mass mailer worms by their nature are sent to many destinations, and analysis of the levels of content provides another tool in detecting such content, and blocking it before it reaches subscribers. This has to be performed by analysis of total traffic loads and individual subscriber loads compared to their normal levels.

Such analysis is not possible with point products on a single PC as they do not see the necessary traffic load, and although possible on a company server running a standard AV scanner, the traffic volume is still too low to yield an effective detection rate in the time required.

It is apparent that content security is most effectively run collectively, or at least communicatively, in order to allow the knowledge of threats to be shared and optimise a collective response to what, after all, is a network security threat. Clearly, the larger the pool of users being collectively protected the larger the pool of knowledge built up to defend against any threat. For example, if a site a site containing malicious code is identified, then it is preferable that any user's access to that site is blocked so that the risk is nullified. However, providing security services to large numbers of users (typical ISPs may have millions of subscribers) presents significant logistical and technical difficulties. These are magnified when it is considered that the security services desired by each subscriber may be different, and that therefore a degree of user configuration of the services should be allowed.

When large numbers of subscribers are involved, it might be considered that the most pressing challenge is performance. Current solutions cannot handle the large volume of traffic typically experienced by ISPs (perhaps 10,000s of pieces of content per second). Often additional platforms, typically standard PCs, are added to address the rising load, but such a solution quickly becomes unstable and cost ineffective.

Latency, too, is a problem. For non real-time applications such as e-mail, adding a few seconds or minutes to the delivery time is not deemed a significant issue. However for real time, or near real-time applications such as downloads or instant messages, adding this level of latency is unacceptable, such that subscribers would not pay for content security (as they lose performance).

To address the performance issues, services are often optimised to perform a small subset of tasks, Though this provides marginal improvements, it results in the user, and indeed the service itself, losing flexibility. The user becomes unable to use the service expressly as desired while the service is no longer capable of adapting to deal with new types of threat. This is especially true when hardware acceleration techniques are employed. The fundamental dichotomy is that only hardware techniques are capable of providing the required performance while only software systems can provide the required flexibility. Consequently, in conventional systems one of performance and flexibility must always be sacrificed.

The challenge, as mentioned above, is not only to provide a system with the required performance and flexibility today, but also one prepared for an uncertain future. Viruses, spam, and content formats are continually changing, presenting a problem of how to provide real-time design elements that can be updated to deliver new techniques as they are developed. Moreover, entirely new and unforeseen threats are doubtless on their way.

Content security products currently keep up to date by the offline analysis of content threats, such as viewing of new websites (and possibly adding to site blocking lists), analysis of samples of content which may contain new malware (which may lead to an update to an AV scanner). This process, although performed as fast as practically possible, takes days, if not weeks to perform.

Though the above discussion refers to content security in particular, similar issues are encountered in content processing of all kinds. Content processing (on, for example, files, web pages, e-mails, information streams such as web requests, and database transaction messages) enables the analysis and modification of data in a variety of applications (in contrast to network devices that operate on packets). Examples of non-security processing may comprise: tailoring advertising to a customer's profile; detecting illegal content being passed over a network; removing confidential information as it passes over a network to prevent accidental disclosure; and reformatting content into more suitable formats. Many more examples of content processing will be apparent to one skilled in the art.

Content processing, and content security in particular, is finding more and more utility in the modern networked environment. Prior systems are simply not prepared for the sheer volume of traffic that must be analysed, especially given the variety of analytical techniques required to offer a truly valuable service.

### STATEMENT OF INVENTION

According to a first aspect of the present invention, there is provided a network-implemented content processing device for controlling the delivery of streamed content to subscribers, comprising:

a stream controller for receiving and storing streamed content;

a plurality of stream processors coupled to the stream controller, each stream processor being adapted to perform one or more predetermined data processing functions on streamed content, thereby providing process output data comprising action data which directs further action to be taken by the stream controller; and,

one or more service processors that are responsive to service requests from the stream controller to apply a subscriber service and produce a service output which is coupled to the stream controller to regulate subscriber access to streamed content in dependence on a service policy associated with the subscriber service, wherein the service requests are built at the stream controller in dependence on the process output data.

According to a second aspect of the present invention, there is provided a method of controlling the delivery of streamed content to subscribers, comprising the steps of:

receiving and storing streamed content at a stream controller;

transmitting streamed content from the stream controller to one or more of a plurality of stream processors, each stream processor being adapted to perform a data processing function on streamed content, each data processing function producing, and returning to the stream controller, process output data that comprises action data which directs further action to be taken by the stream controller;

building, at the stream controller, one or more service requests in dependence on the process output data;

transmitting, in dependence on the action data, one or more service requests from the stream controller to one or more service processors, each service processor being adapted to apply a subscriber service to a service request, each subscriber service producing, and returning to the stream controller, service output data which depends on a service policy associated with the subscriber service; and,

regulating, at the stream controller, subscriber access to streamed content in dependence on the service output data.

The present invention provides an effective, flexible and powerful solution to the content processing problems presented by the modern networked world. Finding particular utility in the field of content security, it is capable of capturing and analysing content both in real time and according to user specified requirements, thereby reducing latency and allowing a high throughput. An integrated device containing both the optimised hardware (the stream processors) and the subscriber flexibility (the service processors) required by users is coordinated by a stream controller designed to ensure full use of the available processing power. The stream processors are adapted to perform one or more functions (such as HTML decoding or protocol decoding) while the service processors effect the final decisions as to how to respond to the results of these functions. To facilitate the subscriber configuration of the services offered by the present invention, the streamed content received by the stream controller preferably comprises a subscriber identifier that identifies the subscriber.

The data processing functions performed by the stream processors preferably comprise both content and protocol processing functions, with a defined boundary between the two types of function. In this way the content processing functions need not be adjusted to perform on data of any protocol (since the protocol processing is performed separately), thereby optimising the use of the available content processing resources.

According to the present invention, regulation of subscriber access may take the form of selective filtering, whereby the subscriber is simply prevented from accessing certain content, or may be more complex. Alternatively, the content itself may be manipulated by addition, subtraction, or alteration, thus allowing the level of subscriber access to be optimised according to the nature of the content processing and the preferences of the subscriber.

In a preferred embodiment, each stream processor is further adapted to transmit streamed content to a further stream processor in dependence on a pipeline command received from the stream controller, wherein the pipeline command depends on the process output data. As such, functions optimally performed by different stream processors may be performed on the same content without the need for the stream controller to transmit the content repeatedly. For example, the process output data produced by a URL extraction function running on a first stream processor may indicate that the body of a web page requires lexical analysis. The stream controller will then assess which of the plurality of stream processors is most suited to the task (criteria for this decision may comprise availability and processing power) and uses the pipeline command to ensure that the relevant data is sent to the chosen processor by the first stream processor.

Since the present invention is network-implemented, it will see the content of many users, allowing it to analyse the traffic and spot trends and anomalies against normal traffic patterns (i.e. perform real-time network based traffic analysis). This is not possible by single user or single company solutions. In addition, this analysis occurs in real-time, and results can be implemented instantaneously (e.g. identify new piece of network borne malware and block to all users).

Preferably, the stream controller is adapted to control the receipt of streamed content by the plurality of stream processors in dependence on the data processing function currently being performed by each stream processor. In this way, the stream controller is aware of the current availability of the stream processors and will direct streamed content to the stream processor most capable of performing the required task. For example, the stream controller will not direct streamed content to a stream processor currently engaged in significant data processing if another equally suitable stream processor is not being used.

The plurality of stream processors is preferably capable of simultaneously performing a plurality of data processing functions on streamed content. The present invention may accordingly provide a parallel architecture where more than one content security function or service may be performed on the data without adding any latency. For example, e-mails may be checked for viruses and spam simultaneously.

In a preferred embodiment, one or more of the stream processors is adapted to identify the data protocol used by the streamed content. The streamed content is then passed to one of these stream processors before it is passed to any other to allow a quick identification of the type of data that is being received (for example, e-mail or web pages). The subsequent data processing is controlled by the process output data produced by that stream processor and will be optimally adapted to the protocol being used (i.e., a web page may not be checked for spam).

The stream controller may perform various services in dependence on the subscriber to which the streamed data is related. For example, a subscriber may be signed up to anti-phishing and anti-virus but not anti-spam. Preferably, this control is effected by the provision of a subscriber policy database containing a subscriber policy, wherein the stream controller is adapted to regulate subscriber access to the streamed content in dependence on a combination of: the subscriber identifier, the data protocol and the subscriber policy.

In addition to this level of user control, the subscriber may also be able to choose how one particular service is configured in itself. For instance, a subscriber may wish all e-mails that are identified as possible phishing to be blocked, or may wish them to be transmitted nevertheless but to be marked in some way as a possible danger. The service policy therefore preferably depends on the subscriber.

The present invention preferably comprises a plurality of different types of stream processor, each type being adapted to perform a different set of one or more data processing functions. As such, the hardware of the present invention is optimised to the task at hand. The stream controller will direct streamed content towards a stream processor of the type optimised for the required type of data processing function. For example, a number of data processing functions may include an element of pattern-matching (which is inefficiently performed by typical microprocessors) so one or more types of stream processor may be adapted to perform this task.

The use of a number of different types of stream processor (e.g. high speed CPU, high speed database, field programmable gate arrays (FPGAs)) provides both flexibility (e.g. if an application requires one function to be used more than others, the relevant type is instantiated more times), and provides extensibility as new or updated functions can be configured onto the stream processor types in the future. Similarly, certain stream processor types may readily take data/information updates (e.g. virus signatures) which are added to the real-time framework.

In one particular embodiment of the present invention, there may be a plurality of service processors and means to share service output data between the service processors, thereby updating the information available to all service processors. In this way, a threat discovered by one service may be identified to the others. For example, links to web addresses in an e-mail discovered to contain a virus may be transferred to a URL filtering (web page blocking) service which will put the suspect web pages on a blacklist and refuse user access to these pages in future. The present invention may effectively use information learnt by one service to update another automatically, and in real-time.

The apparatus may advantageously be operated with a client installed on a subscriber machine, such that the advantages of the streaming architecture further reduce the latency when processing content. The invention permits content to stream through itself, allowing it to be passed with negligible latency to the client installed on the subscriber machine. The client buffers the data on the subscriber machine, but does not pass it to the subscriber application or OS running on the subscriber machine (i.e. prevents user access to the streamed content) until the invention indicates that the content does not require manipulation. The streamed content is not considered to be delivered to the subscriber-until the client-releases it. If the invention determines the content does require manipulating, the invention passes the instructions to the client, which modifies the content it has buffered, then the client sends this modified version of the content to the subscriber applications or OS.

### BRIEF DESCRIPTION OF THE DRAWINGS

Examples of the present invention will now be described in detail with reference to the accompanying drawings, in which:

FIG. 1 shows an ISP network architecture in which apparatus in accordance with one embodiment of the invention is deployed;

FIG. 2 shows a conceptual diagram of the operation of a content security gateway (CSG) in accordance with an embodiment of the invention;

FIG. 3 is a block diagram of the content processor (CP) component of an apparatus in accordance with the invention; and,

FIG. 4 is a block diagram showing the components of a CSG in accordance with the invention.

### DETAILED DESCRIPTION

In order to understand the present invention, aspects of the conventional approaches to content security are now discussed.

Software based solutions are typically written either for client PCs or for deployment on servers (e.g. e-mail, file, proxy). They function well in this environment offering a good solution, but as they utilise standard software, they are limited by the speed of the platform they are operating on. Although the speed of CPUs and platforms is increasing, these solutions are always limited by their compute capacity (particularly where complex algorithms or data manipulation are required) and when deployed in network traffic paths, by the non-optimised manner in which traffic is passed to or from the compute engines, such as interrupts to a non real-time Operating System. Despite these limitations, software solutions do offer a degree of flexibility and can easily be adapted, extended and updated using well known industry tools and techniques.

Examples of software based applications include: AV from Symantec [RTM]; proxy server from Trend [RTM]; Firewall from Checkpoint [RTM]; AS from Brightmail [RTM]; and URL Filtering from SurfControl [RTM].

Hardware acceleration solutions may be viewed as an adjunct of the software based approach, providing high speed dedicated functions in hardware that can be called by existing, or modified, software solutions.

The software solutions, introduced above, implement a number of techniques and functions when performing their content security tasks; e.g. an anti-virus product installed on a PC will scan files, where these files may be compressed in an archive format, such as ZIP. The scanner must first decompress the archive to yield the content. Once the content is available the scanner may perform functions such as pattern searches throughout the content. These two functions, decompression and patterns searches, are both time consuming, and they can be performed much faster by dedicated hardware, hence the use of hardware products to offer high speed dedicated functions. Such hardware acceleration products are useful when deploying content security on servers that handle more content than individual client PCs. An example of this approach is the Tarari [RTM] acceleration product.

The final conventional approach has been the network based hardware solution. These solutions combine the benefits of efficiently designed network equipment with hardware assists for time consuming tasks that would overload a standard software solution. Network devices, such as routers, switches and firewalls, have well designed data paths that optimise the transfer of traffic both through the device and internally within the device, hence freeing this task from software, such that content is presented efficiently for processing by security elements within the device. In addition, the devices may have hardware assists for functions, such as pattern matching and MIME decoding, which are offloaded from software, again expediting the processing of the content security functions.

Whilst these devices offer improved performance over PC based servers, they suffer from the limitations of inflexibility, and are unable to cope with the range of techniques required to detect dangerous, destructive, unsolicited or offensive content. For example the currently implemented hardware assist functions in these products would not be capable of analysis of e-mail for spam, detection of polymorphic and metamorphic malware, or detection of as of yet unknown malware.

Current software solutions, although flexible, cannot in their native form offer a solution which can scale to the required levels of performance required for deployment in large networks, and required for offering protection against all threats across all applications.

Hardware assisted network solutions offer the performance levels required for limited content security functions, but do not offer the flexibility to protect against new threats which require different techniques to detect and intercept them.

The preceding discussion highlights conventional content security solutions, and how they are deployed. These solutions use a number of well known techniques, generically referred to as content security techniques. Some of these techniques are described below.

The content security solutions in operation today utilise a wide range of techniques and mechanisms. In order to assess the type and nature of these techniques that must be incorporated into a next generation network based content security device, a broad study of existing techniques was undertaken, and a sample of the results are highlighted below.

Whitelists & Blacklists: these are used to permit or allow traffic to/from any destination/source specified by either the operator or the subscriber. These are typically trusted sources/destinations in the cases of whitelists, and known sources of unwanted content in the case of blacklists.

Real-Time Blacklists: these are a dynamically updated set of sources which are deemed to be senders of either Spam or malware (c.f. standard blacklists which are static until changed by an operator or subscriber). These lists are continually updated by organisations and are frequently used in anti-spam services.

Message Digests: these digests, also known as checksums, are calculated on each piece of content and define a unique identifier or fingerprint for that piece of content. These digests are collected on content traversing networks and used to identify commonly occurring pieces of content for use in anti-spam services. Note, these digests can be taken on numerous different parts of the message (e.g. limited to invariant parts of a message).

Decompression: frequently content is sent in compressed formats such as archives or as packed content. This requires content security applications to decompress this content in order to analyse it for dangerous, destructive, unsolicited or offensive content.

Bayesian Filtering: this is an algorithm used to correlate a users standard content profile against any incoming content. It is used in anti-spam services to determine if an e-mail is in line with the normal content received by that user, or if it unsolicited content atypical to the users normal messages.

Pattern Matching: this technique searches for patterns or signatures in content. It is useful for detecting malware in files, and also for detecting known words or phrases in content. This technique can be simple in that it looks solely for fixed patterns, or it can be very flexible looking for a set of variable patterns occurring in a particular order at particular places in content.

Heuristics: this is the analysis of content for particular attributes or information, then using these attributes to determine if the content may be dangerous, destructive, unsolicited or offensive. Examples of information include file size, digest value, header format, compile time, patterns etc. This information is then analysed through some form of algorithm which determines what action to take on the content.

Emulation: this widely used term is an umbrella term meaning analysis of the purpose or operation of content. This is contrasted with pattern matching which blindly looks for patterns without an understanding of the nature of the content, whereas emulation involves decoding the content to some degree, sometimes to establish the course of action it takes. Once the content is decoded, the analysis may take the form of instruction distribution checking, or perhaps focus on the course of action undertaken by the content when it is executed.

Tokenisation: this technique is used on lexical content to break it down into phrases or words to allow subsequent analysis.

Lexical analysis: once content has been broken down into the basic words and phrases that constituted it, analysis can be performed on these ‘tokens’ to determine if the content is dangerous, destructive, unsolicited or offensive.

HTML Parsing: this technique scans content in HTML format distilling pertinent information and outputting raw ASCII content if required. An example of pertinent information is white text on a white background (i.e. not visible when rendered) sometimes used in spammed messages. Similar techniques are required for other mark-up languages such as XML.

MIME decoding: non-text content sent over legacy text only protocols (e.g. SMTP) must be encoded prior to transmission; this includes attachments and HTML. This requires content security applications to decode the content prior to analysis.

Packet Classification: this technique is extensively used in networking devices in order to determine the type of traffic passing through the device, where it has come from, and where it should be forwarded onto.

Protocol Decoding: this technique is extensively used in networking solutions such as web servers/clients, e-mail clients/servers etc. The decoding of the protocol messages is a key part of message exchange, and example protocols are SMTP, HTTP, FTP etc.

Content Identification: this technique is required to determine the nature of content that is flowing through a device, in order to determine if it may carry one or more threats. For example, certain file types are not capable of carrying malware, hence establishing the file type will determine if anti-virus content security must be applied.

Firewalling: this technique involves blocking of information on specific protocol identifiers such as UDP port information. This technique is used in defense against protocol based worms.

Network traffic Analysis: this real time technique is used to analyse traffic patterns in order to identify behaviour that may be indicative of dangerous, destructive, unsolicited or offensive content. This typically includes the comparison of normal traffic loads to pre-defined threshold levels.

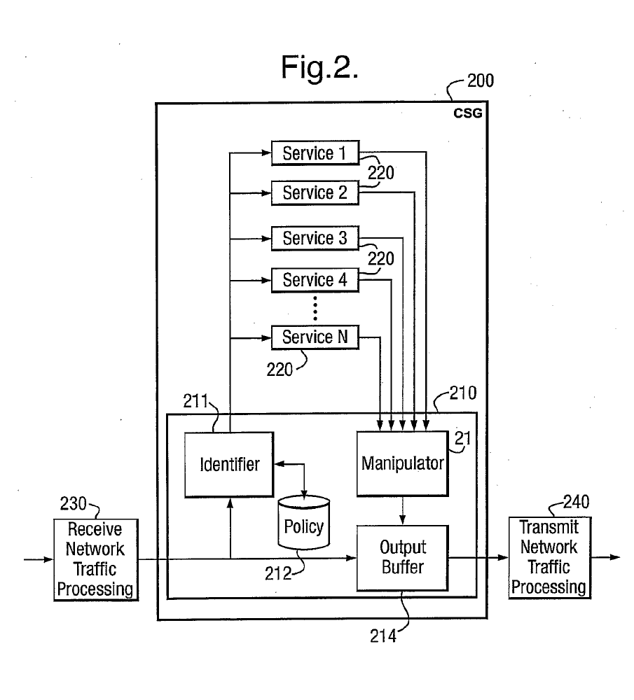

A conceptual diagram of how an apparatus in accordance with the invention operates is shown in FIG. 2: put succinctly, streams of data are captured, analysed, manipulated, and then delivered, thereby regulating subscriber access to the streamed content. FIG. 2 illustrates how a CSG allows a number of services to be performed in parallel on the same stream of data. Network data is received by network traffic processing components 230 and passed as streamed data to a CP 200. A stream controller 210 receives the streamed data and the subscriber is identified 211. Though the identification 211 is shown to occur in the stream controller 210, the physical components used to identify the subscriber may be elsewhere. A subscriber policy database 212 is the consulted to establish which services the subscriber wishes the CSG to perform. As shown, a number of services 220 are then performed in parallel, and a manipulator 213 then alters or does not alter the streamed data in dependence on the output of the services 220 before passing the manipulated stream to the output buffer 214. Once all services are complete the (manipulated) data is passed to further network traffic processing components 240 in order to be transmitted to the subscriber.

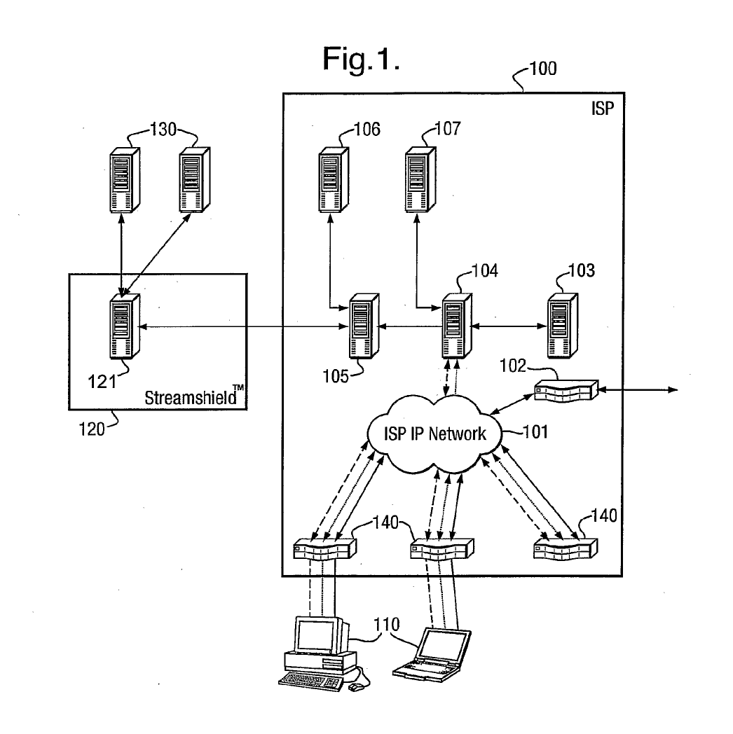

The apparatus is realised as an embedded system product incorporating hardware, software and microcoded elements, which when combined with other standard infrastructure elements, such as web servers and databases, enables the delivery of content security services in real time. In such a realisation, the embedded system can be referred to as a Content Security Gateway (CSG), and FIG. 1 shows one possible deployment solution of the CSG.

FIG. 1 shows how a number of CSGs 140 may be deployed in line with subscriber traffic, in Points of Presence operated by large ISPs or network operators. In the particular embodiment shown the Solution Provider 120 (in this case Streamshield [RTM]) offers content security services to the subscribers 110 of an ISP 100. A number of CSGs 140 are deployed within the ISP's 100 system and are connected to other components via the ISP's 100 internal network 101. The CSGs 140 deployed in the ISP are centrally managed by a single StreamShield [RTM] Server 105 which provides code and information updates, and allows distribution of information between CSGs 140. An ISP administrator 106 also has access to the Streamshield server 105, allowing the ISP 100 to configure the CSGs 140 as required. FIG. 1 also shows how the services provided by the CSG 140 can be integrated into the billing system used by the ISP or network operator, through connection to their authentication (RADIUS) 103 and billing infrastructure 107.

In this embodiment the RADIUS server 103, billing infrastructure 107, and Streamshield server 105 are all connected to the ISP network via the ISP subscription server 104. Additionally, there is a Streamshield.NET server 121 outside the ISP's 100 system which collects updates of information from the CSGs 140 used by any ISP 100 or network service provider, and distributes these to the CSGs 140 via the StreamShield Servers 105 in each ISP 100 or network provider. Note this is just one example of a network infrastructure that incorporates the CSG 140, and other examples could deploy CSGs 140 at the peering points 102 of the ISP (where the ISP core network connects to the Internet) or in front of high load server farms (such as e-mail server farms). Additionally the ISP may re-sell the services made available by the CSG to other ISPs which utilise the ISPs network infrastructure (e.g. Virtual ISPs and second tier ISPs).

The CP employed by the CSG enables it (and, by extension, the ISP) to deliver a number of services (e.g. URL filtering, Anti-Virus) where these services are purchased and used by subscribers. These subscribers can then select which services they wish to be applied to the various applications they may use.

The following are examples of the services that may be offered by the present invention:

URL Filtering: this Service allows the subscriber to define the types and nature of websites that can be viewed across their internet connection. The subscriber selects which categories are allowed (e.g. children's sites), and any access to a site known to fall outside one of the permitted categories (e.g. pornography) is blocked. The Service can also factor-in-usage limits and allow different uses at different-times of the day. Terms such as ‘web access filtering’ and ‘site blocking’ have been commonly used to describe similar services.

Anti-Virus: this Service prevents any malware entering (or leaving) a subscriber's internet connection. This includes all forms of malicious content such as worms, viruses, Trojans, Spyware etc.

Anti-Spam: this service prevents the subscriber from receiving unsolicited messages they do not wish to receive. This includes bulk advertising, scams, hoaxes etc.

Firewall: this service provides a network based firewall to block traffic entering the subscriber internet connection on open UDP/TCP ports. This prevents other internet users from connecting to the subscriber's machines by acquiring information gleaned through port scans.

IDS/IPS: this service (Intruder Detection Service/intruder Prevention Service) protects the subscriber against other internet users connecting to services and machines within their network, through ports which are normally open, such as HTTP (for Web browsing) and SMTP (for e-mail). This includes Denial of Service (DoS) and Distributed DoS (DDoS) attacks.

Application level firewall: this service is aimed at protecting applications and services which are internet facing. This firewall related technology is content aware, for example monitoring for malicious SQL information that may submitted in forms, allowing the attacker to gain access to systems, and for example accelerating XML security functions.

Chat Room Policing: this service restricts access to a set of allowed chat sites, then monitors the traffic sent to/from allowed chat rooms, preventing the divulging of dangerous information such as personal details (e.g. time a child leaves for school) and contact information (e.g. child's e-mail address, telephone number or address).

Anti-Porn: this service blocks access to pornographic images.

Anti-Profanity: this service blocks access to content containing profane, offensive or dangerous language.

Confidentiality: this service blocks confidential information from leaving the subscriber's network through their internet connection.

Nuisance Content Blocking: this service blocks unnecessary content such as cartoons, jokes etc. from entering or leaving through a subscribers internet connection.

Pop-Up Blocking: this service prevents annoying pop-up advertisements being spawned from downloaded web pages

Monitor Service: this allows the subscriber to log the traffic sent and received through their internet connection over a defined period. This allows them to track their internet usage, and monitor which websites are visited, chat rooms are visited, e-mail correspondents etc. etc.

Traffic shaping: this service allows the network operator (e.g. ISP) to restrict the amount of traffic allowed for an application (e.g. P2P) hence ensuring there is sufficient bandwidth for subscribers other applications such as web browsing.

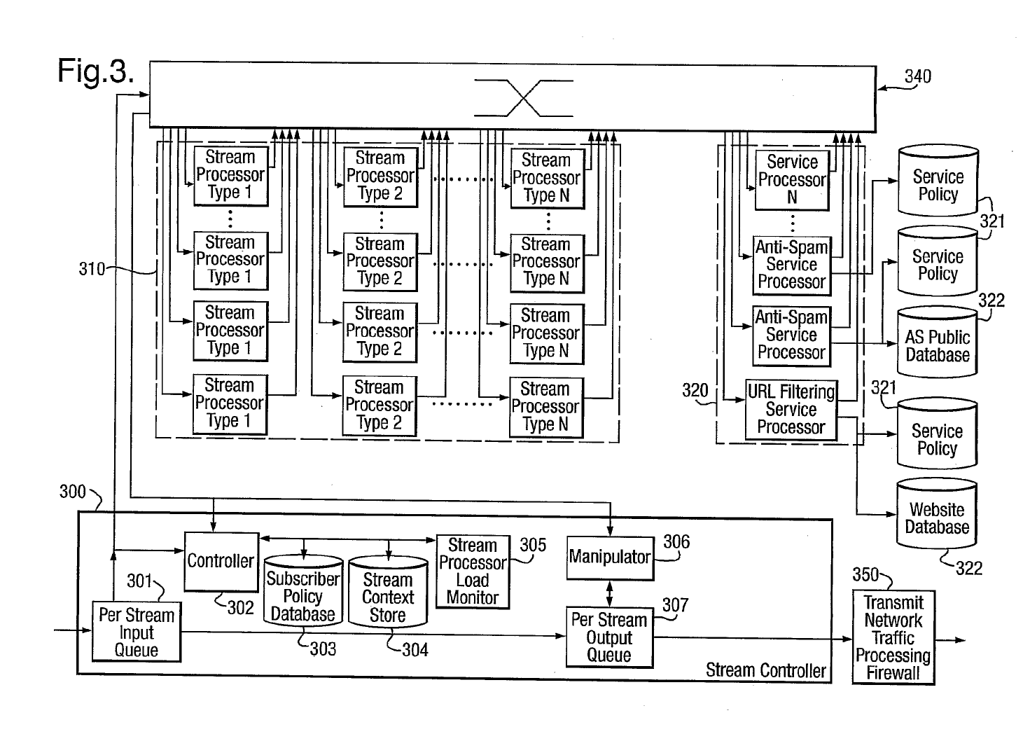

FIG. 3 shows a block diagram of the CP, which comprises a stream controller 300, an array of stream processors 310, and a number of service processors 320. It is the interaction of these three elements that provide the high throughput and low latency performance of the present invention. As explained below, it provides all the advantages of hardware acceleration with all the flexibility of purely software solutions.

In use, data is streamed into the CP, where it is received and stored by the stream controller 100, where it is received by an input queue 301. The stream controller 100 contains a controller 302 which may direct the streamed data to its appropriate destination and if the protocol of the data is unknown then it will be passed to one of a plurality of stream processors 310 adapted to perform a function to identify data protocols. The identification stream processor function will either return a result indicating the data protocol if enough data has been received, or indicate that more information is required.

During the processing of a stream of data, a stream context store 304 is used to collate information (referred to as stream context data) on the current status of the stream. It is this data that will indicate that whether the stream has yet been identified.

The data protocol identification is effectively a preliminary step before further processing takes place. The result is returned to the stream controller 300 as process output data. Once the data protocol is known, the service processor can assess which services (such as anti-phishing or anti-virus) are available for that data. If the subscriber has subscribed to that service then it will performed by the CP. A subscriber policy database 11 contains the subscriber policy indicating what services each subscriber has paid for or requested.

As described below, the services are then applied by a combination of the stream processors 310 and service processors 320, which are connected to each other and the stream controller via interface circuitry 340. A stream processor load monitor 305 in the stream controller 300 is used to ensure that tasks are allocated effectively to the stream processors 310. The actions of the service processors 320 are dependent on service information stored in service policy databases 321 and may also depend on one or more public databases 322 (public databases may hold, for example, information on known sources of spam or details of known websites). The service information is typically provided by the Solution Provider and may include subscriber preferences. Once the services have been applied a manipulator 306 performs any required manipulation of the streamed data. The streamed data is then passed to an output queue 307 before being released to the subscriber through a transmit network processing firewall 350.

The subscriber may be identified using a subscriber identifier incorporated into the streamed content. Typically, this may be added by the network traffic processing (NTP) subsystems which will be described in greater detail later. In short, the NTP will add an identifier based on the network address of the source or destination of the streamed content.

Though this technique provides a level of personalization for the services offered, a large company or organisation may have hundreds or thousands of employees, each sharing the same network related information. Consequently, since the network information for each subscriber is not unique, a further means of distinguishing between subscribers may be required. According to one embodiment of the present invention, a further level of subscriber identification is added, whereby the functions of the stream processors are utilised to distinguish and identify individuals with the same network details. In this embodiment, the content processor will parse each stream looking for further information that may be used to identify the subscriber; for example, in an e-mail stream, the name of the subscriber will appear in the To: or From: field, thereby allowing identification of the subscriber, and hence application of that subscriber's individual policy.

Subscriber identification in such embodiments may therefore be considered a two stage process: the first stage being the extraction by the NTP of a network identifier and the passing on of this information to the CP, and the second stage being the use of the CP to finally identify the subscriber. It is important to bear in mind that the CP may not need to perform any further processing to identify the subscriber once the network identifier is known. The term subscriber may represent all those using a network, or alternatively may represent one of a number of individuals using that network.

A service may require a number of functions to be performed, and each stream processor is optimised to perform one or more of these data processing functions. The stream processor will therefore transmit the streamed data to the relevant functions. It is important to bear in mind that a function may or may not depend on the result of another. According to the advantageous parallel architecture of the present invention, a plurality of functions may be undertaken simultaneously in order to effect one or more services.

Each function will produce one or more sets of output data (referred to collectively as process output data) which indicates which, if any, further functions need to be undertaken before the service can complete. A non-exclusive list of examples of the type of outputs that may be produced runs as follows:

1. Context information: this may contain details of the status of a particular stream that is being processed by a stream processor (such as whether the stream processor has arrived at a result or requires more data).

2. Results: for example, if the stream processor has established that the streamed content contains an HTTP Message then the process output data will contain this information and a requirement that the streamed content is sent to a URL filtering service.

3. Derived stream: the stream processor may create a new stream from the streamed content, in such cases the process output data will inform the stream controller of this and detail what type of stream processor the new stream should be passed to next.

The stream controller will act in dependence on the process output data it receives (which may come from a number of stream processors) and ensure that further stream processors receive the relevant aspects of the streamed content as required. Advantageously, the stream controller is aware of the current load on and capabilities of each of the stream processors (for example using Stream Processor Load Monitor). As such, the stream controller will ensure that streamed data is transmitted to a stream processor that is both not busy and capable of performing the required function.

The following is an illustrative, but not exhaustive, list of functions that may be performed by the stream processors:

Protocol Recognition: when a stream arrives into the system, this function determines what the stream is (e.g. an e-mail/SMTP stream, a web browsing/HTTP stream etc,), and collects related statistics (e.g. how may SMTP streams in progress).

Protocol decode: once a protocol is recognised the next function operated is usually a full protocol decode of that protocol

MIME Decode: content sent over certain protocols may be MIME encoded, and this function decodes this encoded content

Content Recognition: where a stream is carrying content over a protocol, this function operates on the decoded protocol stream and determines the type of content being carried (e.g. HTML document, .exe file, Word Document etc.)

Decompression: content being carried through a network may be in a compressed form (e.g. zipped) and this function operates on compressed content to convert to its normal format.

HTTP message extraction: this function operates on HTTP decoded traffic and extracts the GET and other messages, then converts them into a form suitable for fast lookup in the web filter databases.

Content Extraction: this function extracts content from the protocols that carry it (e.g. extract an attachment from an e-mail in order to send it to the virus scanner).

Virus scanner: extracted content, of specified types, is sent to this function to be scanned for viruses, and a result is returned. Note today, these functions contain two parts, the first part pre-processes the content into a format suitable for the scanners, and the second part is the actual virus scanner.

HTML Decode: this function has an HTML parser and decodes HTML documents.

HTML Scanner: this function works closely with the HTML decoder and analyses HTML for malicious code (this can range from detecting certain HTML Tags such as I-frames to detecting scripts embedded in the HTML which have viruses in them). Note, this function, although including similar capability to the Virus scanner, is implemented in a radically different manner using different techniques, hence it is listed separately, and certain streams bearing HTML go to this function, certain streams bearing files go the virus scanner; and certain streams which include content of both types have each piece of the content sent to the appropriate function after being recognised.

XML Decode: this function has an XML parser and decodes XML documents.

Mail Header Extraction: this function extracts e-mail header information such as the sender domain and recipient domain.

Tokenisation: this function acts on content containing words (e.g. .txt files, e-mail bodies) and breaks the content down into words or phrases.

Content Signature Calculation: this function calculates a digest or signature which uniquely identifies this piece of content. This function is used to detect frequently occurring pieces of content.

Bayesian Filtering: this function operates on content comparing this against a reference and deducing the likelihood of an e-mail being typical of the reference.

Lexical Heuristics: this function operates on tokenized content and runs an algorithm which determines if an e-mail is similar to known spam content. The algorithm is updated and improved over time, but initially it attributes scores to certain words or phrases and sums these scores to deduce a result.

Content Volumetrics: this functions determines how frequently a piece of content has been seen on the internet by using a signature to index a database of such signatures, where each database entry is updated every time the entry is seen on the network.

Each stream processor may be optimised to perform one or more of the above (or other) functions. For example, a number of the above functions involve an element of pattern-matching and so one or more stream processors will be adapted to perform that process (or sub-function). It is likely that there will be a number of identical stream processors, and that it is therefore convenient to consider the plurality of stream processors to be divided into a plurality of different types of stream processor. As such, each function will be preferentially performed by one type. For example, the HTTP Get function may be performed by a type 1 stream processor. Thus, when the stream controller requires the HTTP Get function to be performed it will send the data to a type 1 stream processor (which is not currently busy).

Examples of the different types of stream processors include, but are not limited to:

1. Processor circuits running lightweight real time operating systems, typically used where running content security functions best suited to software (e.g. re-using existing third party software solutions, functions which are not compute intensive such as database look-ups);

2. Bespoke designed circuits using FPGAs, which are typically used on specific tasks which are compute intensive (e.g. mathematical calculations);

3. Dedicated silicon available from industry vendors (e.g. image analysis silicon); and

4. Bespoke designed FPGA/CPU combinations where the processing requirements demonstrate a clear need for dedicated high speed hardware functions and closely coupled lower speed functions.

The stream processors are interconnected through conventional computer interconnect such as shared busses or switch fabrics. Note, these stream processors can be housed on daughter cards, such that the main circuit boards holding the stream processors can be configured with different combinations of stream processors, and indeed support new stream processors in the future. For example, a main card could contain say twenty stream processors of a single type, or ten of two stream processor types. The configuration of types is not in any way limited by the example shown in FIG. 3.

These stream processors can be configured with different processing capabilities dependent on the need of the solution in which they are being deployed. For example, the stream processors operating software may have many possible tasks (e.g. protocol decode, database lookup, virus scan, run third party software etc.) where any task is operating at any one time on the CPU execution unit(s). The FPGA based stream processors can be configured with different processing capability such that they have twenty different unrelated functions, or twenty of the same function, where all operate in parallel.

As an example of the benefit of the combination of different types of stream processors, consider a stream processor running a third party software solution (as mentioned above). This stream processor running this software may be an industry standard processor with an industry standard operating system—it is thus a simple matter for replacement or updated third party software to be acquired and used. However, further stream processors optimised to perform the functions common to all these solutions (such as protocol decoding and file extraction) may be provided to accelerate these ‘non-core’ functions thus providing a significant performance benefit (in contrast to previous systems which use the same processor for all required functions). Advantageously, switching between third party solutions will have no effect on the benefits obtained in this way.

The invention may also benefit from third party information (in the form of lists or databases, for example), with certain stream and service processors adapted to utilise information stored in common, industry standard formats and keep in step with their developments.

The CP thus has all the flexibility of previous software security systems to run various security services (since it may contain processors running software) and all the power of accelerated hardware security components (since it may also comprise these). It is also readily upgraded with new components (either further stream processors or further software) and benefits from the fact that a number of stream processors can perform separate functions in parallel at any given time. As the CSG is a network-implemented solution, it is also possible to track network traffic for any type of content related patterns (such as the number of viruses, the distribution of file sizes, the most commonly visited websites, or the most common downloads).

As the data processing functions are performed by the stream processors, the CP builds a service request in dependence on the process output data. This includes any information discovered that is relevant to that service. For example, if the streamed data is an e-mail, the anti-spam service may be activated and one of the functions may have detected that the e-mail originated from a suspect source—this information may be included in the service request.

Once all the functions have been performed for a particular service, the service request will be passed to one or more of the service processors 320 shown in FIG. 3. There is typically one service processor per service, though there may be a further ‘master’ service processor adapted to share information between the services (for example, if a virus is discovered from a particular website then details of that website may be shared with a site blocking service so that it is in future always blocked). These service processors are typically simply different processing functionality placed onto one of the standard stream processor types, but their role is in making the final decisions required when a service processes a piece of content.

When a service processor receives a service request, it consults an associated service policy database 321 and acts accordingly. The service policy database 321 contains a service policy listing the subscriber's preferences for that service. For example, individual users may have individually tailored site block lists that will be operated by a URL filtering service. Further databases available to the service processors may include non-subscriber specific information such as known sources of spam. If it is discovered that the streamed data does represent a security threat (under the subscriber's adopted services, and, within them, service preferences) the action instructed by the service processor may also depend on the user's preferences stored in the service policy. For example, the anti-spam service element may determine what action to take on an e-mail (e.g. reject as spam, forward to subscriber, forward with modifications, forward but add more content etc.) and this will depend not only on the service request but also on the service policy.

If a user is to be prevented from accessing content, then this may be done in a number of ways. In a simple case, the stream controller will not pass streamed content/data to the user until it has been cleared by all the relevant services. A manipulator 306 may be included in the stream controller to manipulate the stream as instructed by the service processor before the stream is sent to the subscriber's machine. However, it is also envisaged that, in order to minimise latency, client software may be installed on the subscriber's computer that provides a ‘holding area’ for unchecked data.

When a client is installed, the invention permits content to stream through itself, allowing it to be passed with negligible latency to the client installed on the subscriber machine. The client buffers the data on the subscriber machine, but does not pass it to the subscriber application or OS running on the subscriber machine (i.e. prevents user access to the streamed content) until the invention indicates that the content does not require manipulation. Once the CP has established whether any manipulation is necessary, then the client is instructed accordingly. Having performed the necessary manipulation, the client then releases the modified data to the user applications or OS (it may be that the content was blocked and, as such, the modified data contains little or none of the original streamed content).

Consider now the memory requirements of a CP capable of simultaneously processing a large number of separate streams. If the content transferred across these streams is small (say measured in 10s of kilobytes), this content only remains within the CP for short periods of time, placing a modest buffering requirement on the stream controller (which, as stated above, stores the streamed content as it enters the CP).

However, if the stream is carrying large pieces of content, say files in excess of 1 Mbyte, this can place a considerable buffering requirement on the controller, which maintains an output queue per stream. For example, it is possible that entire pieces of content must be received, and stored, before a service may complete. Without a client, this data may run into gigabytes that must be stored in output queues at the stream controller.

The output queues may be held separately to a limited input buffer used to transfer data to the stream processors for the performance of the functions. Since the CP is arranged to process traffic at the rate at which it is received this is only required for peaks in the processing load. During such peaks it may be possible that all stream processors capable of performing the required functions may be busy, and as such the data is buffered until they become available.

Moreover, the stream processors themselves may have a limited amount of storage, allowing them to store temporarily the streams they are currently processing. The most significant buffering requirements are therefore in the output queues used by the CP when there is no client installed on the subscriber's computer. As described above, the use of a client allows the content to be streamed straight through the CP, thereby nullifying the requirement for extensive buffering at the CP.

There are many different implementations that could be used to deliver apparatus in accordance with the invention. In particular, various different processing units could be used to provide the stream processors and service processors (e.g. different busses, different ways to connect the elements together etc.).

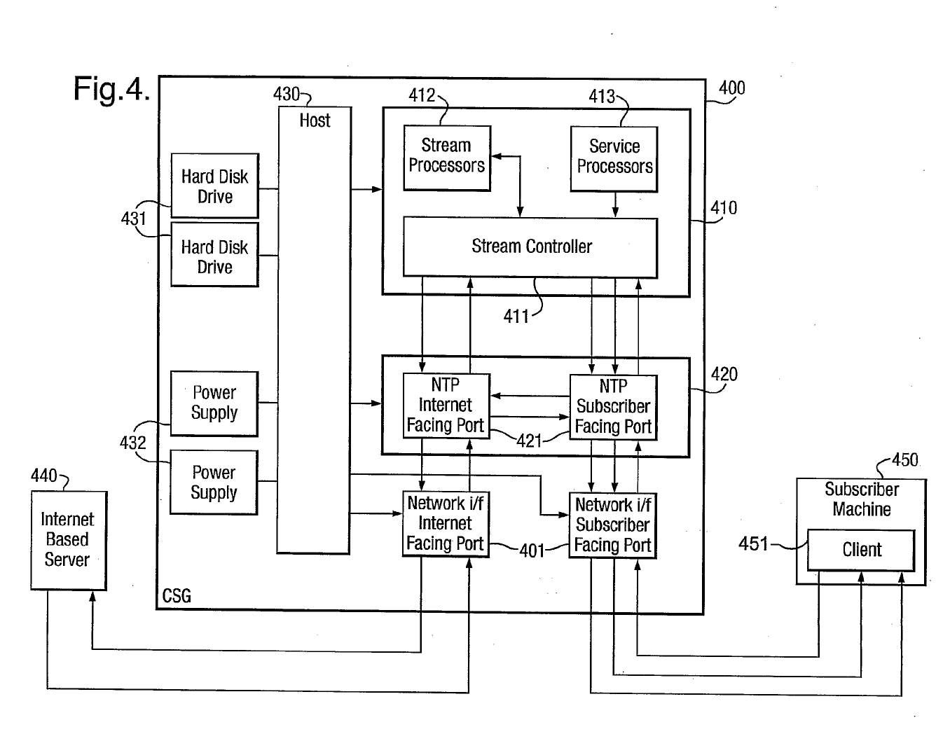

FIG. 4 is a block diagram showing the components of a CSG 400 (comprising a CP 410). The CSG 400 is placed on a network between an internet based server 440 and a subscriber machine 450. A client 451 of the type described above is shown installed on the subscriber machine 450. The CP 410 is shown to comprise a stream controller 411, an array of stream processors 412, and a number of service processors 413. Both the NTP 420 and the CP 410 are supported by host hardware 430 having storage 431 (i.e. hard disk drives) and a power supply 432. Having described the CP in some detail, we now turn to the other components, in particular the NTP 420.

The NTP 420 is responsible for identifying which traffic should have services applied to it, then capturing this content from the protocols that carry it, and then presenting it as streamed content/data to the CP for processing. Note the NTP 420 is multi-protocol aware, and can extract content from any carrying protocol such as TCP, UDP, or IP.

The CSG network ports 401 are connected to those of the NTP. The NTP interfaces to standard network ports 421 (e.g. 10/100 Ethernet, 1 Gbit/s Ethernet, FDDI, OC12, STM16 etc.) which transmit and receive traffic to/from the networks which are connected to the CSG.

The CSG is intended to provide services for subscribers, however its deployment within the network may mean that non-subscriber traffic is also passed through the CSG. Therefore the NTP 420 must identify subscriber traffic and non-subscriber traffic. This is done through comparing the source IP address, destination IP address and protocol information of traffic arriving on each network port, and comparing these IP addresses against a list of IP addresses (Access Control List or ACL) currently used by subscribers. Note this ACL can be determined by a number of techniques, three of which are listed below:

1. The CSG detects RADIUS (or similar) authentication & accounting packets, which are exchanged by the subscriber and the ISP infrastructure, and intercepts these. These packets include the subscriber name (e.g. john.smith@mylSP.com) and can include the IP address which the ISP assigns to that subscriber when they are ‘logged on’. The CSG then checks the subscriber name against a list of subscribers to it services, and if a match occurs, the IP address of that subscriber is added to a local database.

2. A similar log-on process may utilise the well-known DHCP protocol to assign an IP address, and again these message are detected by the CSG and the association between subscriber identifier and IP address assigned is learnt.

3. The ISP may assign subscribers to the managed service to use a fixed and defined set of IP addresses, hence these are programmed directly into the NTP.

The NTP receives packets from the subscriber facing and internet facing ports, and for each packet arriving from either port, it combines the source, destination and protocol information into a flow identifier. The NTP then looks this flow identifier up in a database. If this is the first packet received on a flow, the database will yield a result indicating a new flow. At this point the NTP undertakes the following checks:

1. If the packet is from the subscriber facing port it looks up the source IP address in the ACL. If the result indicates the traffic is from a subscriber it creates an entry in the flow database, indicating that traffic on this flow should be passed to the CP. If the ACL lookup indicates the traffic is from a non-subscriber it creates an entry in the flow database indicating the traffic should pass directly out of the NTP without being passed to the CP.

2. If the packet is from the Internet facing port it looks up the destination IP address in the ACL. If the result indicates the traffic is from a subscriber it creates an entry in the flow database, indicating that traffic on this flow should be passed to the CP. If the ACL lookup indicates the traffic is from a non-subscriber it creates an entry in the flow database indicating the traffic should pass directly out of the NTP without being passed to the CP.

Therefore, future packets received using this flow will yield a result for the flow database indicating to the NTP whether to pass the traffic to the CP or bypass it through the CSG without further processing. This bypass route is very low latency such that non-subscriber traffic is forwarded in real-time with negligible delay.

Note, for traffic carried over UDP or TCP the protocol information used to construct the flow identifier consists of protocol type, and the destination and source port numbers. For traffic carried over other protocols the protocol information used to construct the flow identifier is simply the protocol type (e.g. ICMP).

When the NTP has determined whether-packets should be processed by the CP, for packets sent over a TCP connection or over UDP, the NTP extracts the payload from these protocols, to yield a stream, and passes information received on this stream to the CP with an accompanying subscriber identifier. Note, this stream may arrive at the CSG over a sustained period of minutes, hours or even days, and as each piece of information arrives the NTP extracts the stream information and passes this to the CP with the identifier. Recall that this identifier does not distinguish between separate subscriber's using the same network connection, and that further subscriber identification techniques may also be performed by the CP.

The NTP achieves this by terminating TCP connections locally within itself. This means that instead of a TCP connection forming end-to-end between the subscriber machine and a destination machine, one connection forms between the subscriber and the CSG, and a second forms between the CSG and the destination machine. When a new flow using TCP is detected, and the NTP determines it belongs to a subscriber, at this point the two connections are set-up. Note, the session layer protocol (e.g. HTTP) is still end-to-end, although the CP may manipulate information passed over this session. The CSG may operate the TCP termination in the manner of a conventional network proxy (e.g. each connection utilises distinct network and link layer addresses), or in a transparent manner such that these link layer and network layer addresses are identical on the pair of TCP connections.

The same “transparent” approach is used for UDP and other protocols.

The termination of these TCP connections permits the CP to modify content as it passes between end-points, ensuring that any changes to the content made by the CP do not cause communication problems. If the TCP connections were still end to end, as the CP modifies the content, the acknowledgement functionality of TCP would cause problems, as the information sent by one party would be different to that received by the other (as the CP has modified it), causing continuous re-transmit requests.

As described previously, the CP components of the CSG are designed to operate on a large number of streams of user content captured by the NTP, where the streams may transfer varying amounts of content over varying amounts of time. The CP is arranged to process the amount of content it has received at any point of time.

As mentioned above, code and information updates may be provided in order to ensure that the CSG offers state of the art services. As such, the present invention is adapted to allow the CP to receive such updates, thereby protecting the subscriber against recently developed threats (such as new viruses or spam messages generated with new obfuscation techniques) Preferably the update process is implemented in such a way that the subscriber experiences no loss of service as the CP is updated.

According to one embodiment of the present invention, when a code or information update is required, the host 430 (shown in FIG. 4) is provided with new code or information comprising a marker indicating the required destination of the update. An update may be specific to, for example, a type of stream processor, a stream processor function, a service processor, or any of the associated databases. The update is passed to the stream controller and then directed to its final destination.

The code or information updates may be divided broadly into two types. The first type is an ‘incremental’ update whereby the relevant code or information may be absorbed by the relevant component (stream processor, service processor etc.) without the component going off-line (i.e. the component continues to function normally during the update). The second type, requiring a temporary suspension of the component, may be referred to as a ‘replacement’ update, and on receipt of this type of update the relevant component will indicate to the stream processor that it is not capable of functioning at this time. When the replacement update is complete the component will indicate to the stream processor that it is ready to function again.

An advantage of the present invention is that were one component to go offline the subscriber need not be aware of this fact since other components are available. For example, if a stream processor is taken off-line to be updated then the remaining stream processors will simply take up the load (if all the stream processors need to be updated then the update will performed one stream processor at a time). Indeed, this is done if a stream processor is off-line for any reason (for example, if the stream processor is damaged or has failed).

As described above, the content processing capabilities of the invention allow the streams of information to be converted from packets to pieces of content such as files, web pages, e-mails etc., and thereafter perform functions on this content. One such function is to calculate a fingerprint or digest (e.g. MD5) of the content which uniquely identifies this piece of content. Note this digest identifies the piece of content as it flows through the network, not the network packets which encapsulate and transfer this content.

A preferred embodiment of the present invention includes a further function which then stores information on these computed digests in a real time embedded database, along with information associated with each digest such as the network source of the content to which the digest belongs, the type of content, the number of times the content has been detected in the network over a period of time by the invention etc. This database of content related information can then be provided to external management systems (such as the StreamShield Server or 3^{rd} party Network Management Systems) in order for the network operator to determine the quantity, type and nature of content flowing through their network.

In this way such a management solution is able report this content information to show, for example, the most common file downloads occurring through their network, the number of downloads through their network happening against time on a graph, or the most viewed web page browsed through their network.

We now turn to specific examples of a CSG in use in accordance with the present invention:

Consider first the provision of a URL filtering service: the subscriber is provided with the ability to block access to certain websites, by specifying a list of categories that are to be blocked. For example, the subscriber may wish to permit access to websites for sports related content, but block access to sites containing pornographic content. The subscriber configures this information through a standard management system, and this information is then passed to the CSG, and knowledge that this subscriber must have the URL Filtering Service applied is stored in the CP Stream Controller subscriber policy database, while service specific information is then stored in the CP URL Filtering service policy database.

The CSG is also configured with a database of website addresses (domains and/or IP addresses) with a category associated with each. This database is also passed to the service processor within the CP associated with the URL Filtering service.

The subscriber now begins a web browsing session, and enters the website address of a site hosting sports related content, and this site is included in the website database loaded into the CSG. When the subscriber enters the site URL, the browser forms a TCP connection to the host site in a standard manner, and the NTP within the CSG operates as described previously, identifying a subscriber TCP connection and then directs the stream information sent across that TCP connection to the CP; this stream has a unique identifier, and when created the CP is passed this stream identifier, the subscriber identifier and information on the stream. In response, the stream controller creates an entry for this stream, containing this information, in a Stream Context Store, marking it as a new stream of unknown type.

The streamed content is now being passed to the CP in sections as it arrives over the network, each time with the unique stream identifier. The stream controller looks up the stream in its Stream Context Store, and realizes it is of an unknown type, hence it sends the stream to a stream processor capable of identifying the stream. It may be that not enough streamed content has been received at this stage for the stream processor to identify the data protocol, and in that case the stream processor will send a result back to the stream controller indicating this, and may store itself a local copy of the stream information it has been sent to date.

When the next part of the stream arrives, the stream controller again uses the Stream Identifier to send the streamed content to either the same stream processor used previously, or another stream processor adapted for protocol identification, and this stream processor uses the new information, and any necessary stored information, and if it has enough information to identify the stream it sends the result back to the stream controller indicating the traffic is an HTTP stream (in this example), and also including a stream pointer indicating to the stream controller which part of the stream has been identified.

The CP now knows the stream type and the subscriber identifier and uses the subscriber policy database store to determine that the URL Filtering Service should be applied to this stream. As a result, content received after the stream pointer is sent to a stream processor to perform a Protocol Decode function.

This Protocol Decode function then extracts the URL (e.g. www.sportscontentsite.com) from the HTTP stream, and process output data is returned to the stream controller. This process output data indicates that the URL, along with the stream identifier and a stream pointer indicating the point which had been reached in processing the stream, should be passed to the service processor associated with the URL filtering service. Note that, where appropriate, a function may further process extracted data (including the process output data). For example, in this case the function may also calculate a digest of the URL, where this computed digest would be used by the service processor if its database of URLs was encrypted, such that it is accessed through a digest, rather than clear text.

The URL Filtering service processor then looks up the URL in a website database, returning the category Sports, and looks up the subscriber's service policy using the subscriber identifier, which verifies that this category is permitted by the subscriber. Therefore no action should be taken on the web request, and this result is returned to the controller along with the stream pointer information.

Note, that the stream processors and service processors operate on a copy of the original content, which has been stored by the stream controller in parallel. The stream controller uses the stream pointers calculated by itself and the functions to determine how much content should be ‘released’ onto the intended destination. For example, when the URL Filtering service processor has determined that the Web request should be permitted, the controller may have 1200 bytes worth of information stored on that stream. The web request that is to be allowed may have been 800 bytes in size, and this is information is stored by the stream pointers calculated by the functions, hence the stream controller allows 800 bytes to be sent, retaining the remaining 400 bytes that have yet to be cleared.

If the URL Filtering service processor had determined that the site should be blocked, as it was categorized as a site that the subscriber had configured to be blocked, then the URL Filtering service processor would then pass an HTTP response which includes an HTML ‘block’ page to the stream controller, the response containing information specific to this stream (e.g. block reason). At this point, the stream controller will delete the 800 bytes (as indicated by the stream pointers), and then pass the HTML block page content to the NTP, along with the stream identifier. In turn, the NTP sends the block page on to the subscriber, where it is rendered by the subscriber's browser. The content of the block page, or indeed whether one is sent at all, may be a subject of the subscriber policy, thus allowing the personalization of the URL filtering service.

The stream identifier also has a sub identifier which indicates the direction of content flowing on a stream, as any TCP connection has content flowing in both directions; this sub-identifier, which simply indicates the direction of flow is sourced by the NTP, and used by the stream controller.

The URL Filtering service may also be responsible for providing other web access control functions such as limiting the amount of time a subscriber can browse the web, or limiting access to certain times of day. The service processor is provided with the necessary raw information to execute these checks. For example, when service requests are passed to it (in dependence on process output data) they may include the subscriber identifier and the time the TCP connection was opened. Note, the service processor may also collect statistics on the nature and type of websites visited and usage statistics (e.g. most commonly visited sites).

In the case where the CSG permits a subscriber web request to pass through it, either because it is to an uncategorized website not included in the website database, or because the site is known but allowed by the subscriber's policy, the CSG also inspects the content that is returned in response to that permitted web request.

The process undertaken is initially similar to that undertaken on the web request, in that the stream is first classified as an HTTP stream, and as a response, and that this stream belongs to a subscriber who should have the URL Filtering Service applied. At this juncture, the following process occurs.

The streamed data will then be sent to a content identification function which identifies it as an HTML page, and the stream controller then directs the stream to an HTML parsing function. If the web page has PICS meta tags included in the header, these are extracted and details are built into the service request, though the service request is marked as unfinished at this stage and as such is not acted on by any service processor. The function continues to parse the HTML content, and extracts any words included in the content (as opposed to rendering tags). These words are then sent to a lexical analysis function (this may occur on the same stream processor, but does not have to), and the results of the lexical analysis function (e.g. high quantity of sex related words) are used to build the service request further. When the HTML parsing is complete, the service request is marked as finished, and the URL Filtering service processor now acts upon the supplied results to determine if the page should be blocked. Note, to determine the required action the URL Filtering element maps the PICS meta tags to a category, and uses a similar mapping to relate the lexical analysis result to a category.

If none of these results yield a category which has been requested to be blocked by the subscriber, then the stream controller is instructed to release the content, again using stream pointers to ensure only the correct data is released. If the URL Filtering service does determine that the page contains content that should be blocked, then it returns the block page to the stream controller, including the reason for the block.

It is the stream controller that is in overall control of which functions are called and where their results are sent, though it does so in response to process output data returned to it by the stream processors. In one preferred embodiment, the stream controller is microcoded with the knowledge of the algorithm that should be used to process each type of content. Considering the example above, the stream controller schedules:

1. Protocol identification.

2. HTML parsing, on receipt of process output data indication that the streamed content is HTML. In particular, parsing involves initially finding PICS meta tags, which are then detailed in the service request.

3. Further HTML parsing, streamed content is passed to the lexical analysis function, the results of which are again built into the service request.

4. Once the HTML parsing is complete, the service request is passed to the URL filtering service processor for the service processor to calculate the final result.

Note, the process output data produced during the HTML parsing stage may indicate that further functions, or indeed services, must be undertaken. For example, if an image is found, this is sent to the Image Analysis function, its results being incorporated into to the service request. Alternatively, if active content is found which can carry malware, then the AV Service may be scheduled.

In the example where a web page being retrieved by a subscriber contains both images and lexical content, where the stream controller causes multiple services and multiple functions to be operated on this content, these functions typically operate in parallel, but where one function is dependent upon the output of another, this output is piped directly to the dependent function. This process is scheduled by the stream controller as follows:

1. The stream processor performing the HTML Parser function detects an image in the web page, and creates process output data informing the stream controller accordingly

2. The stream controller determines which stream processors are available to process the image, and then instructs the most suitable stream processor to expect a stream for image analysis from the HTML Parser function

3. The stream controller then instructs the HTML Parser function to send the image (and only the image) directly to a stream processor determined by the stream controller

4. Subsequently, the HTML Parser function detects text in the web page, and informs the stream controller accordingly

5. Stream controller determines which stream processors are available to process the text, and then instructs the most suitable stream processor to expect a stream for lexical analysis from the HTML Parser function

6. The stream controller then instructs the HTML Parser function to send this text (and only the text) directly to the stream processor the stream controller has chosen for lexical analysis

7. The stream controller receives process data from the stream controllers performing the three functions (HTML parsing, image analysis, and lexical analysis) and a service request is built up in dependence on the process output data

8. When the functions are complete, the service request is acted upon by a service processor which in turn instructs the stream controller how to handle the stream (i.e. whether it should be transmitted to the user)

This above illustrates how work is divided between the various components. The controller determines which services need be applied, then, in response to process output data provided by the HTML parsing function, determines which further functions are required. The parallel architecture is well illustrated by the above example. At times, all three functions may be enacted at once (the HTML parsing searching for further text or images, and the image and lexical analysis investigating the images and text that have already been identified).

The above gives an example of how the CP may process subscriber content, but it is important to bear in mind that the CP also analyses the results of the functions and services to allow them both to be updated. In the example above, where the returning content was blocked, the URL of the outgoing allowed request has been stored in a stream context store, and when the URL Filtering service determines that returning content should be blocked, the URL would be added to a website database under an appropriate category (the category representing the nature of the blocked data). Similarly, if the returning content had contained active content, which was found to carry malware, that URL would also be added to the website database under an appropriate category.

The above sections indicate how web access is controlled for the subscriber, but site blocking is also provided on other applications such as file transfer, which uses the File Transfer Protocol (FTP). The same process as described above is used, where the initial FTP application opens a TCP connection which causes the CP to process content being sent across that connection. Again, the CP identifies the protocol type, and using the subscriber identifier determines that the destination must be checked. The protocol is decoded further as traffic arrives into the CP, and if the destination site, or domain, is found to be in a category requested to be blocked, the FTP session is not passed on by the CSG. Similarly, if the destination domain is permitted, the returning content will be examined and have any necessary functions applied in pursuit of the required services; e.g. if the file is deemed capable of carrying malware, the anti-virus service is executed on the content.

We now turn to the example of an anti-virus service provided in accordance with the present invention. The process of identifying any malicious content which may be dangerous or destructive is performed by the anti-virus service. This service is run on any application (e.g. web browsing, IM), and the process undertaken for e-mail is described below.

The subscriber opens his/her e-mail client and requests to pick up e-mail, causing the e-mail client to execute a series of mail operations over a protocol such as SMTP, POP3 or IMAP. These cause the client to first open a TCP connection, which the NTP handles in the manner described in previous sections, causing the CP to open an entry in the stream context store, which holds information including the subscriber identifier. Again, the CP receives content arriving on this stream, and sends it to an identification function that is available to analyse the protocol which is eventually (in this case) decoded as that used by e-mail, and the subsequent content is sent to a content identification function. This process occurs in the manner described in previous sections where, as each piece of content arrives, it is sent on to a stream processor by the stream controller. The stream processor may hold a limited copy of the content, and both the stream controller and the stream processor use stream pointers to determine where they are in processing the incoming stream, whilst this stream is simultaneously stored.

As more content arrives on the stream, it is acted on by a function used to analyse the mail headers and body. This includes analysis of MIME headers and if these headers indicate the mail is carrying an attachment, which is not compressed in any way, the function performs any necessary MIME decoding, then identifies the file type (e.g. .exe, .vbs, .jpg) using a file analysis algorithm. Once the file type is determined, this result is passed to the stream controller, indicating the file is capable of carrying malware. The stream controller then determines if the subscriber should have the AV Service applied, and if so the stream controller instructs the stream processor performing the file analysis function to send its output (a MIME decoded stream, with header information including information such as Stream Pointers, Stream Identifier etc.) to stream processor(s) capable of performing the AV function(s). The stream pointer ensures that the stream includes the entire file.

Typically, the AV functions are commercial AV scanners, and the stream is sent in parallel to as many different scanners that are installed. They may also be additional AV functions used. Again, the stream controller ensures the streamed content is sent to stream processors capable of performing the required functions (there may be a preset algorithm that the stream controller follows for each file type). Some AV functions may require access to the entire file, and so stream processors designed for these functions will have significant storage capabilities. To summarise, at this stage the streamed data containing the attachment has been MIME decoded, and this decoded version may reside in multiple stream processors providing multiple AV functions, and the original stream is stored by the stream controller. The stream processors running the protocol, content & file identification functions and the MIME decoding function may now discard their content.

As the AV functions are performed, process output data is being returned upon which a service request is being built. When the service request is ready, the AV service processor analyses these multiple results with a suitable algorithm (e.g. if any one result indicates a virus is present, block traffic), and accesses the subscriber's service policy to determine how the detected virus should be processed (e.g. delete, quarantine), sending the result as instructions to the stream controller. The AV service may also, if a virus is detected, provide a subscriber specific ‘scan message’ to the stream processor, such that the e-mail is forwarded onto the subscriber minus the attachment, but with suitably modified headers and scan message added. This scan message is provided as a set of bytes, with control information instructing the stream controller where to add it into the stream.

This example shows how the stream controller has caused a derived copy of the stream (a MIME decoded version) to exist within the CP for a limited period during application of the AV Service to the content. The CP also includes stream processors that are capable of decompressing content if it were archived (e.g. zipped) or packed. Taking the example above, if the attachment was compressed, the identification function will determine this from analysis of the MIME headers and information from within the file, and pass this result to the stream controller. The stream controller will then instruct the function to send the stream (which may be a derived one after MIME decoding) directly to a stream processor capable of decompression, which again derives a new stream which yields the attachment ready to send to the AV function(s).

Note, these pipelined functions operate on the content as it arrives into the CSG, processing pieces of size say 1 Kbyte, as each 1 Kbyte of content is captured by the NTP. This reduces the latency in applying content security services. For example, if a subscriber is downloading a 100 Kbyte file, and two functions must be applied where the second operates on the output of the first, both the functions will operate in series on 1 Kbyte pieces as they arrive, being called 100 times.

The above examples illustrate how file based content is processed when operating the AV service, but malware can exist in other forms, such as low level protocol based worms (e.g. W32/slammer), hoax messages, and as active content embedded with web pages. The AV Service also verifies that content is free from malware of these types by the following means:

Web borne active content: taking the web access example provided earlier, each web page is parsed by an HTML parser function within the CP, which identifies any scripts or other active content. This information is passed to the stream controller (with the usual stream identifier and stream pointers) which instructs the parser function to send this part of the stream to one or more AV-capable stream processors (to run, for example, 3rd party scanners, pattern matching, or emulation). The results build a service request which is passed to the AV service processor. If the active content identified is deemed to malicious, then the AV service passes stream pointers to the stream controller with the request for deletion of the content, or if necessary, blocking of the entire page. The stream controller then makes the modifications to the outgoing stream and sends it to the NTP which in turn sends it to the subscriber.

Protocol based worms: these are simple packet based malware which can replicate at high speed due to their simplicity, and as they do not constitute a file, they are not detectable by traditional PC based virus scanners which hook OS file operations. This protocol based information is sent through to the CP in the normal manner, and a copy of the stream is sent to a stream processor to perform a complex pattern matching function used to check the stream for any known worms. This pattern matching is of the form of well known industry standard Intrusion Detection Systems (IDS), and if a worm pattern is detected, a service request is built and sent to the AV service processor, the service request comprising stream pointers to identify the boundaries of the worm in the stream, and the pattern that was matched. The AV service processor correlates this information with other operations in progress on that stream, and with a suitable algorithm, determines the content is a malware worm, updating local statistics on worm activity. The AV service processor passes this decision to the stream controller, which, using the stream pointers as guides, blocks the transmission of any worms.

The technique above is used to detect and intercept known worm malware, but this still permits new, as of yet unknown, worm malware to propagate. These worms are detected by a combination of NTP operations and functions used in the normal manner by the CP. The protocol worms typically use UDP, TCP ports and IP protocols (e.g. ICMP) to attack vulnerable machines on the internet, and the NTP monitors defined traffic metrics such as the amount & rate of connections being opened over TCP, the volume of UDP and IP protocol traffic etc. If these metrics cross pre-defined thresholds, samples of the content are sent to the CP, with the detected threshold & statistics information. This causes the stream controller to create an entry in the streams context store and the content received on this stream is sent to one or more functions, where each function may operate a different algorithm, and each function may operate in parallel, where these functions are dedicated to analysing the information and content received from the NTP. If these functions determine that a new worm may be in circulation, the results are sent to the AV service processor, which operates an algorithm to determine what actions should be taken. The AV service processor instructs the stream controller to take these actions in the normal way, except that this algorithm may yield an additional action for the NTP, such as to close a TCP or UDP port. This is passed to the NTP as a control message defining the port(s) to be closed, in which direction(s) they should be closed, and for what length of time.

The sections above describe how the CSG described delivers an anti-virus service for e-mail based application. The same algorithm and process is used to deliver the same service on content transferred over other applications such as HTTP, FTP, peer-to-peer, IM etc. The only difference is the protocol decoding phase.

The above sections also highlight the parallelism and pipelining used in the execution of the service. The worm detection, and AV scanners all execute in parallel returning results when available, and the pre-cursor MIME decoding and decompression stages are pipelined.

The last example that will be discussed in detail herein is that of an anti-spam (AS) service. As before, the streamed content is first acted on by a protocol decode function, which identifies the stream as SMTP (for example), once sufficient content has arrived. The content type is then identified, and process output data is produced. If, for example, the content is revealed to be plain (ASCII) text, then the stream controller may send the content to stream processors designed to perform the following functions:

1. Header extraction which yields information on the sender, e-mail title etc.

2. Digest calculation (e.g. MD5).

3. Tokenisation, which splits the mail down into a series of words or phrases.

A service request is built independence on the results of the above functions, and is passed to the AS service processor, which is adapted to perform a suitable algorithm. One example of such an algorithm is:

1. Use header information to check sender is not listed as a source of spam, by checking source information against publicly available information stored in a local blacklist database.

2. Compare the digests calculated on the ASCII text against publicly available databases of commonly occurring mail digest (spam digest database stored locally); if digest in database, classify as spam.

3. Run a rule based heuristic algorithm on the tokens extracted from the mail.

4. Run the tokens through a Bayesian filter, which has been primed by a separate learning process, which is refined by the subscriber.

The AS service processor then returns a service output that depends on the results of the algorithm and the subscriber's service policy. The stream controller then regulates user access to the streamed data in the usual way.

Though the CP is described above in the context of a CSG, in some embodiments, the CP may be supplied as a PCI card, or without the NTP component, (or without a host, for that matter). These embodiments may find particular utility, for example, a corporate environment where throughput is lower.

Furthermore, as discussed above, there are many more potential services than are described in detail above. For example, an anti-phishing service that may advantageously be employed by the present invention is described is Applicant's co-pending European patent application EP05250157.4. In general terms, the apparatus is a means for intercepting content of a defined type, then, on a per user basis, analysing then possibly modifying that content in a defined way. Examples of non content security applications the present invention may enact include: adding tailored advertising to per user traffic; analysing internet borne images (e.g. for law enforcement); analysing internet borne websites (e.g. for law enforcement); monitoring e-mail & IM messages (e.g. for law enforcement); and automatically categorizing all web sites. Similarly, the throughput power of the CSG could be used as a way of analysing bulk traffic offline, e.g. scan 1 million images.

The present invention provides unprecedented power and flexibility to the constantly expanding and developing field of content analysis, with particular utility in Content security.

1: A network-implemented content processing device for controlling the delivery of streamed content to subscribers, comprising:
a stream controller for receiving and storing streamed content;
a plurality of stream processors coupled to the stream controller, each stream processor being adapted to perform one or more predetermined data processing functions on streamed content, thereby providing process output data comprising action data which directs further action to be taken by the stream controller; and,
one or more service processors that are responsive to service requests from the stream controller to apply a subscriber service and produce a service output which is coupled to the stream controller to regulate subscriber access to streamed content in dependence on a service policy associated with the subscriber service, wherein the service requests are built at the stream controller in dependence on the process output data.

2: A device according to claim 1, wherein each stream processor is adapted to transmit streamed content to a further stream processor in dependence on a pipeline command received from the stream controller, wherein the pipeline command depends on the process output data.

3: A device according to claim 1, wherein the stream controller is adapted to control the receipt of streamed content in dependence on the data processing function currently being performed by each stream processor.

4: A device according to claim 1, wherein the plurality of stream processors is capable of simultaneously performing a plurality of data processing functions on streamed content.

5: A device according to claim 1, wherein each data processing function is either a content processing function or a protocol processing function.

6: A device according claim 1, adapted to receive code and information updates effective to update one or more of a data processing function and a service policy, without loss of service.

7: A device according to claim 1, wherein service output data associated with one subscriber service is effective to update the service policy associated with one or more further subscriber services.

8: A device according to claim 1, wherein the streamed content received by the stream controller comprises a subscriber identifier that identifies the subscriber.

9: A device according to claim 8, wherein the service policy depends on the subscriber identifier.

10: A device according to claim 1, wherein one or more of the stream processors is adapted to identify a data protocol used by the streamed content.

11: A device according to claim 10, further comprising a subscriber policy database for storing a subscriber policy, wherein the stream controller is adapted to transmit streamed content to one or more stream processors in dependence on a combination of: the subscriber identifier, the data protocol, and the subscriber policy.

12: A device according to claim 1, comprising a plurality of different types of stream processor, each type being adapted to perform a different set of one or more data processing functions.

13: A device according to claim 1, wherein the subscriber service is chosen from a group including the following: anti-virus services, anti-spam services, anti-phishing services, and content control services.

14: A device according to claim 1, wherein one of the data processing functions is effective to calculate a digest on the streamed content, the digest being subsequently stored with associated information, thereby enabling statistical analysis of the content passing over the network.

15: A method of controlling the delivery of streamed content to subscribers, comprising the steps of:
receiving and storing streamed content at a stream controller;
transmitting streamed content from the stream controller to one or more of a plurality of stream processors, each stream processor being adapted to perform a data processing function on streamed content, each data processing function producing, and returning to the stream controller process output data that comprises action data which directs further action to be taken by the stream controller;
building, at the stream controller, one or more service requests in dependence on the process output data;
transmitting, in dependence on the action data, one or more service requests from the stream controller to one or more service processors, each service processor being adapted to apply a subscriber service to a service request, each subscriber service producing, and returning to the stream controller, service output data which depends on a service policy associated with the subscriber service; and,
regulating, at the stream controller subscriber access to streamed content in dependence on the service output data.

16: A method according to claim 15, further comprising the step of transmitting streamed content from one stream processor to a further stream processor in dependence on a pipeline command received from the stream controller, wherein the pipeline command depends on the process output data.

17: A method according to claim 15, wherein the streamed content is transmitted by the stream controller to the plurality of stream processors in dependence on the data processing function currently being applied by each stream controller.

18: A method according to claim 15, wherein the plurality of stream processors simultaneously perform a plurality of data processing functions on streamed content.

19: A method according to claim 15, wherein each data processing function is either a content processing function or a protocol processing function.

20: A method according to claim 15, further comprising the step of receiving code and information updates effective to update one or more of a data processing function and a service policy, without loss of service.

21: A method according to claim 15, wherein service output data associated with one subscriber service is effective to update the service policy associated with one or more further subscriber services.

22: A method according to claim 15, wherein the streamed content received by the stream controller comprises a subscriber identifier that identifies the subscriber.

23: A method according to claim 22, wherein the service policy depends on the subscriber identifier.

24: A method according to claim 15, wherein a preliminary data processing function to be performed on the streamed content identifies a data protocol used by the streamed content.

25: A method according to claim 24, wherein the transmission, after the identification of the data protocol, of streamed content to one or more stream processors is dependent on a combination of: the subscriber identifier, the data protocol, and a subscriber policy stored in a subscriber policy database.

26: A method according to claim 15, wherein the plurality of stream processors comprise a plurality of different types of stream processor, each type being adapted to perform a different set of one or more data processing functions.

27: A method according to claim 15, wherein each subscriber service is chosen from a group including the following: anti-virus services, anti-spam services, anti-phishing services, and content control services.

28: A method according to claim 15, wherein one of the data processing functions is effective to calculate a digest on the streamed content, the digest being subsequently stored with associated information, thereby enabling statistical analysis of the content passing over the network.
